(19) United States
(12) Patent Application Publication
(10) Pub. No.: US 2026/0218713 A1
(43) Pub. Date: Jul. 30, 2026

(54) BLOWER WITH A GAS PRESSURIZATION SYSTEM

(71) Applicant: WALLENBERG UNION LLC, NEWARK, DE (US)

(72) Inventor: David LUO, NEWARK, DE (US)

(73) Assignee: WALLENBERG UNION LLC, NEWARK, DE (US)

(21) Appl. No.: 19/036,512

(22) Filed: Jan. 24, 2025

(51) Int. Cl. F04D 17/10; A62B 7/02; F04D 25/06; F04D 29/42

(52) U.S. Cl. CPC F04D 17/10; F04D 25/06; F04D 25/064; F04D 25/0646; F04D 29/281; F04D 29/4226; A62B 7/02

(57) ABSTRACT

A blower with a gas pressurization system. The blower includes a blower housing with a gas inlet and a gas outlet, a brushless direct current motor including a rotor assembly, a stator assembly, at least one permanent magnet, and bearings, and an impeller positioned between the stator assembly and the gas inlet. The housing and the outer surface of the motor are configured to collectively form a gas passage that provides a helical gas flow. During operation, gas enters the gas passage of the blower through the gas inlet. The stator assembly drives the rotation of the rotor assembly, causing the rotor assembly to drive the impeller at high speed, thereby pressurizing the gas to a range of 2 cmH₂O to 40 cmH₂O. The pressurized gas then flows through the gas passage of the blower and is expelled through the gas outlet.

### TECHNICAL FIELD

The present disclosure relates to a blower with a gas pressurization system. The blower includes a blower housing, an impeller, and a brushless direct current (BLDC) motor. The housing includes a gas inlet and a gas outlet. The impeller is positioned between the stator assembly and the gas inlet of the housing. The BLDC motor includes a rotor assembly, a stator assembly, at least one permanent magnet, and bearings.

### BACKGROUND

The fast pace of modern life, coupled with increasing work and lifestyle pressures, has brought significant changes to people's daily habits. These changes often include reduced physical activity, unhealthy eating patterns, and insufficient sleep. At the same time, the global trend of population aging has led to a growing proportion of elderly individuals, among whom chronic respiratory diseases are becoming increasingly prevalent. Moreover, air pollution and deteriorating air quality have had a profound impact on respiratory health. Long-term exposure to polluted air can trigger or worsen various respiratory conditions. Together, these factors contribute to the rising number of individuals suffering from respiratory-related diseases, emphasizing the critical importance of maintaining respiratory health.

Respiratory-related diseases commonly include chronic obstructive pulmonary disease (COPD), asthma, pneumonia, bronchitis, pulmonary fibrosis, and obstructive sleep apnea syndrome (OSAS). Effective treatment for these conditions requires tailored approaches based on their specific characteristics and severity. Among these, OSAS is one of the most common conditions. It is primarily treated using household ventilators, with the blower serving as the core component that delivers the therapeutic gas pressure required for treatment.

Blowers in ventilators can be classified into several types. Based on operating principles, blowers are primarily categorized into centrifugal blowers and axial blowers. According to airflow delivery methods, they can be classified as unidirectional blowers and bidirectional blowers. Based on regulation methods, they can be divided into constant-pressure blowers and adjustable-pressure blowers. Blowers currently used in ventilators typically include the following components: an impeller, which is the core component of the blower. Blowers currently used in ventilators typically include an impeller, a brushless direct current (BLDC) motor, bearings, a control circuit, and a housing. The impeller, as the core component of the blower, is usually directly driven by a high-speed BLDC motor to achieve efficient airflow and pressure regulation. The BLDC motor provides the power to operate the blower and can be a DC-powered motor, an AC-powered motor, or other types of servo motors. Bearings support the impeller and reduce friction during rotation, ensuring efficient and stable operation. A control circuit adjusts parameters such as the speed and power of the BLDC motor to regulate airflow output and pressure levels. The housing protects the internal components, guides gas flow, dissipates heat from the gas passage, and offers some degree of sound insulation. These components work together to ensure that the ventilator provides stable and comfortable respiratory support. During operation, the power source drives the BLDC motor, which rotates the impeller through the shaft. The high-speed rotation of the impeller causes gas to be continuously drawn into the blower through the gas inlet. Inside the blower, the gas is pressurized to a range of 2 cmH₂O to 40 cmH₂O and then flows through the gas passage formed by the blower housing to the gas outlet, completing the operational process.

### SUMMARY

This disclosure addresses the aforementioned shortcomings by providing an ozone disinfection device that is user-friendly, cost-effective, and comfortable to wear.

The objective of the present disclosure is to provide a blower with a gas pressurization system that, through improvements in its internal structure, achieves an appropriate noise range, extends the blower's lifespan, and facilitates the manufacturing of blowers for respiratory devices. This design enables the blower to quickly adapt to market demands while addressing the limitations of similar products in the prior art. The disclosure aims to provide a blower that is more efficient, applicable to a wider range of scenarios and environments, and equipped with superior handling capabilities. The blower supplies a continuous positive airway pressure (CPAP) to the user, offering an effective treatment for sleep-related breathing disorders.

In one embodiment, a blower with a gas pressurization system is provided. The blower includes a blower housing, an impeller, a casing, and a brushless direct current motor. The blower is configured to pressurize gas to a range of 2 cmH₂O to 40 cmH₂O and deliver pressurized gas to an outlet of a respiratory device. The blower housing is configured to enclose an internal structure of the blower and form a gas passage for helical gas flow, including a gas inlet and a gas outlet. The impeller includes a plurality of blades and at least one casing, and it is configured to accelerate the gas flow entering the blower and guide the gas flow radially. The brushless direct current motor includes a rotor assembly, a stator assembly, at least one permanent magnet, and bearings. The motor has a first end nearer the blower housing and a second end away from the blower housing. The impeller is attached to the first end of the motor via the rotor assembly and is driven by the motor. The gas passage is divided by the impeller into a first region above the impeller and a second region below the impeller, with the space in the second region being larger than or equal to the space in the first region. At least 50% of the gas outlet is located in the second region, and the vertical distance between the lowest plane of the second region away from the impeller and the impeller is greater than or equal to 10 mm.

In one embodiment, the blower housing includes at least two parts that are joined together to form a complete blower housing.

In one embodiment, the stator assembly includes a stator assembly housing, which is exposed to the gas passage and reduces the temperature of the stator assembly as the gas flow passes through the gas passage.

In one embodiment, the stator assembly is exposed both to the gas passage inside the blower and to the external environment outside the blower housing.

In one embodiment, the impeller includes a central opening, and the gas inlet of the blower is configured to constrain the central opening of the impeller.

In one embodiment, the impeller is coaxially aligned with the blower housing.

In one embodiment, the upper casing of the impeller includes a protrusion at the central opening.

In another embodiment, a blower with a gas pressurization system is provided. The blower includes a blower housing, an impeller, a casing, and a brushless direct current motor. The blower is configured to pressurize gas to a range of 2 cmH₂O to 40 cmH₂O and deliver pressurized gas to an outlet of a respiratory device. The blower housing is configured to enclose an internal structure of the blower and form a gas passage for helical gas flow. The blower housing includes a gas inlet and a gas outlet. The impeller includes a plurality of blades and at least one casing. The casing includes an upper casing and a lower casing. The upper casing and the lower casing are configured to clamp the plurality of blades and form multiple impeller channels. The impeller is configured to accelerate the gas flow entering the blower and guide the gas flow radially through the multiple impeller channels. The brushless direct current motor includes a rotor assembly, a stator assembly, at least one permanent magnet, and bearings. The motor has a first end nearer the blower housing and a second end away from the blower housing. The impeller is attached to the first end of the motor via the rotor assembly and is driven by the motor. The gas passage is divided by the impeller into a first region above the impeller and a second region below the impeller. The space in the second region is larger than or equal to the space in the first region. At least 50% of the gas outlet is located in the second region.

In one embodiment, the upper casing gradually decreases in height downward in a radial direction relative to an axial direction.

In one embodiment, the impeller includes a central opening configured to be an inlet for the gas flow into the impeller channels, and each blade decreases in height from the central opening to the periphery of the impeller.

In one embodiment, an edge of each blade at the central opening forms an angle with the lower casing, the angle being less than 90°.

In one embodiment, a vertical distance between a lowest plane of the second region away from the impeller and the lower casing is greater than or equal to 10 mm.

In yet another embodiment, a blower with a gas pressurization system is provided. A blower with a gas pressurization system includes a blower housing, an impeller, a casing, and a brushless direct current motor. The blower is configured to pressurize gas to a range of 2 cmH₂O to 40 cmH₂O and deliver pressurized gas to an outlet of a respiratory device. The blower housing is configured to enclose an internal structure of the blower and form a gas passage for helical gas flow. The blower housing includes a gas inlet and a gas outlet. The impeller includes a plurality of blades and at least one casing. The casing includes an upper casing and a lower casing. The upper casing and the lower casing are configured to clamp the plurality of blades and form multiple impeller channels. The impeller is configured to accelerate the gas flow entering the blower and guide the gas flow radially through the multiple impeller channels. The brushless direct current motor includes a rotor assembly, a stator assembly, at least one permanent magnet, and bearings. The motor has a first end nearer the blower housing and a second end away from the blower housing. The impeller is attached to the first end of the motor via the rotor assembly and is driven by the motor. The lower casing includes a first sheet and a second sheet, the first sheet and the second sheet being coaxially aligned. The gas passage is divided by the impeller into a first region above the impeller and a second region below the impeller. The first region and the second region are configured such that gas flows through a gap formed between the second sheet and the blower housing. The gas flows at high velocity through the impeller channels in the first region and subsequently enters the second region where the gas flow is buffered.

In one embodiment, the diameter of the second sheet is greater than the diameter of the first sheet.

In one embodiment, a gap is formed between the second sheet and the blower housing, the gap being uniformly distributed along a periphery of the second sheet and configured to allow the gas to flow evenly from the first region to the second region.

In one embodiment, a thickness ratio of the first sheet to the second sheet ranges from 0.7 to 1.3.

In one embodiment, a space in the second region is larger than or equal to a space in the first region.

In one embodiment, a space in the second region is small compared to a space in the first region.

In a further embodiment, a blower with a gas pressurization system is provided. A blower with a gas pressurization system includes a blower housing, an impeller, a casing, and a brushless direct current motor. The blower is configured to pressurize gas to a range of 2 cmH₂O to 40 cmH₂O and deliver pressurized gas to an outlet of a respiratory device. The blower housing is configured to enclose an internal structure of the blower and form a gas passage for helical gas flow. The blower housing includes a gas inlet and a gas outlet. The impeller includes a plurality of blades and at least one casing. The impeller is configured to accelerate the gas flow entering the blower and guide the gas flow radially. The brushless direct current motor includes a rotor assembly, a stator assembly, at least one permanent magnet, and bearings. The motor has a first end nearer the blower housing and a second end away from the blower housing. The impeller is attached to the first end of the motor via the rotor assembly and is driven by the motor. The stator assembly includes a stator assembly housing, with an outer surface of the stator assembly housing at least partially exposed to the gas passage. This configuration allows convective cooling of the stator assembly during operation of the blower. A non-integral tube is provided between the rotor assembly and the stator assembly. The stator assembly includes a stator with a central hole and multiple coils arranged in a distributed winding configuration. These multiple coils include phase coil groups for a multiphase switched reluctance brushless direct current motor. The stator further includes multiple protruding stator teeth, along with multiple laminations and insulating materials that wrap around the laminations.

In one embodiment, the non-integral tube is constructed with two parts, with a gap inside the blower separating the two parts.

In one embodiment, the motor includes a flange configured to support the blower housing.

In one embodiment, the rotor assembly includes a metal component configured to contact and secure the impeller.

In one embodiment, the rotor assembly and the stator are coaxially aligned and do not form a gas gap.

In one embodiment, the gas does not flow through an interior of the stator assembly.

Implementing the blower of the present disclosure has at least the following beneficial effects:
1. To enhance the noise-reducing performance of the blower, reduce the impact of respiratory devices on users, and improve user comfort, the structure of the blower and its components have been comprehensively improved, tested, and continuously optimized. These efforts have resulted in a blower that offers reduced noise levels and improved comfort compared to products currently available on the market. Initially, the internal gas passage of the blower housing was relocated downward relative to the impeller, and its spatial configuration was optimized. This was combined with a unique impeller partitioning design to refine the internal gas flow path of the blower. On this basis, the impeller was replaced with a quieter and more efficient closed impeller, which includes an upper casing and a lower casing. Additionally, a uniquely structured motor design was implemented to achieve better matching between the impeller and the motor. The optimized impeller and motor pairing, along with the improved gas passage inside the blower housing to provide helical gas flow, resulted in significant overall enhancements. These improvements contribute to a blower design that offers increased benefits for users. The enhancements not only improve the noise-reducing performance of the device but also provide practical advantages for users, leading to notable improvements in overall product performance and user experience.
2. Designing the impeller with multiple casings offers several advantages. (a). The impeller includes an upper casing and a lower casing that clamp multiple blades between them, forming more enclosed impeller channels. These enclosed channels reduce gas leakage from the sides of the impeller and effectively guide the gas flow along optimized paths. This ensures smoother gas flow through the impeller, reduces turbulence and energy loss, and results in higher efficiency compared to open and semi-open impellers, typically achieving an efficiency increase of 1-3% over semi-open impellers. Additionally, this design improves the overall sealing performance of the blower, reducing gas backflow losses and further enhancing the blowers' efficiency and performance. (b). The upper casing and the lower casing provide better guidance for the gas flow, ensuring smoother flow within the impeller. This reduces the formation of vortices and turbulence, thereby lowering the likelihood of noise generation. Moreover, the impeller in this disclosure has greater rigidity, leading to reduced vibration during blower operation. Its robust and symmetrical structure enhances balance and stability, further contributing to noise reduction and ensuring more stable operation. (c). The impeller in this disclosure maintains stable performance under relatively higher gas pressures. This stability is primarily due to the structural design of the upper casing and the lower casing, which enhances resistance to pressure and deformation. This ensures reduced pressure fluctuations and stable operation under high-pressure conditions. Such advantages are particularly significant for ventilators that require frequent pressure adjustments during operation. The impeller's ability to adapt to varying gas pressures makes it an ideal choice for ventilators, extending the device's lifespan and ensuring reliable performance over time.
3. The addition of the second sheet divides the previously unified internal gas passage for helical gas flow into two separate regions. This division offers multiple advantages that are unattainable with traditional blower designs. In conventional blower designs, gas is drawn in through the inlet, accelerated by the impeller, and directly expelled through the outlet. The gas passage is relatively short, and high-velocity gas exiting the impeller flows directly to the housing edge or the volute tongue. This limited space often causes turbulence as the gas enters the volute tongue, reducing the blower's efficiency. Furthermore, turbulence at the impeller edge and the volute tongue generates additional noise. In this disclosure, a second sheet is provided below the first sheet of the impeller. The inclusion of the second sheet enables the high-velocity gas exiting the impeller channels to transition more smoothly as it moves from the first region to the volute tongue (i.e., through the second region). This design reduces the impact of the gas flow. In the first region, gas flows at high velocity, while the uniform gap between the second sheet and the inner surface of the blower housing allows gas to transition evenly into the second region below. This design eliminates (or significantly reduces) turbulence caused by flow separation at the impeller edge and volute tongue, improving blower performance and reducing noise. Additionally, the space in the second region is larger than or equal to the space in the first region. When the space in the second region is larger than the space in the first region, as the gas flows from the first region into the second region, the increased volume slows the gas velocity and increases gas pressure. The reduced velocity not only decreases turbulence but also enables this blower to operate across a wider pressure range while noticeably lowering noise levels compared to traditional blowers. The diameter of the second sheet is greater than that of the first sheet, which helps prevent gas backflow, reduce noise, and enhance the blower's overall performance and noise-reduction capabilities. Dividing the gas passage into two regions also extends the gas passage, reducing flow impact, lowering noise levels, and improving efficiency.
4. Lowering the gas passage to the central position of the blower provides the following advantages. (a). By positioning the gas passage at the central part of the blower, the gas flow entering the blower passes over the motor, carrying away the heat generated during motor operation. This assists in motor cooling, maintaining the motor within an appropriate temperature range, and prevents overheating caused by prolonged use. As a result, the motor's operational efficiency and lifespan are improved, which in turn enhances the overall efficiency and durability of the blower. (b). In conventional blower designs available in the market, the gas passage is positioned near the impeller. In these designs, the pressurized gas exiting the impeller immediately enters the gas passage and is discharged. This abrupt transition results in sudden, rapid changes in the gas flow, which can cause turbulence or irregular flow patterns, increasing the blower's noise levels. Additionally, the sudden changes may induce fluctuations in the gas flow, further contributing to noise problems. In contrast, lowering the gas passage to the central position of the blower provides a buffering space for the pressurized gas flow. This design allows the gas flow to transition more smoothly and uniformly along the gas passage, reducing turbulence and irregular flow within the blower, thereby reducing noise. (c). By integrating the functionality of the second sheet, the originally unified gas passage designed for helical gas flow is divided into a flow path from the first region to the second region. Lowering the gas passage expands the previously limited space, allowing the second sheet to fully perform its intended function and create a more optimized flow path. With the gas passage lowered, the airflow in the second region transitions more gradually, avoiding abrupt changes caused by spatial constraints. This design reduces turbulence formation and lowers the blower's noise levels. Moreover, this improvement enhances the aerodynamic performance of the entire gas passage, improving both the efficiency and stability of the blower. The noise-reducing capabilities of the second sheet are further amplified through this design, resulting in quieter and more efficient blower operation. (d). When the blower uses a closed impeller, it differs from non-closed impellers in that its blades are enclosed within a casing. The closed impeller has a central opening through which the gas enters, passing through impeller channels formed by the blades. This design allows the pressurized airflow to be discharged from the enclosed structure at a higher pressure. In contrast, non-closed impellers have a more open structure, which permits airflow to move freely on both sides of the impeller without significant path restrictions. As a result, blowers with closed impellers require the gas passage to be lowered, providing additional space for the pressurized airflow to be guided more effectively. This enhances the performance and efficiency of the blower. (e). In addition, designing the gas passage at the central position of the blower contributes to improved stability when integrated into respiratory devices. In conventional blower designs, the internal gas passage is typically positioned near the top of the blower. However, in this disclosure, the gas passage is shifted downward, resulting in the overall center of gravity being closer to the central position of the blower. This adjustment reduces mechanical vibrations caused by changes in airflow pressure and velocity, improving operational stability and safety. Furthermore, this design allows the blower to be more securely mounted within respiratory devices, reducing wobbling and ensuring a stable installation, further mitigating motor noise caused by vibrations.
5. The motor has been improved with a key enhancement involving the use of insulating material to wrap the laminations, ensuring that the coils do not come into direct contact with the laminations. This design offers several advantages: (a). The insulating material wrapped around the laminations strengthens the motor's electrical insulation and reduces electromagnetic interference. It effectively prevents electrical short circuits between the laminations and other motor components, avoiding unintended current flow between windings or between the windings and the motor housing. Additionally, it suppresses magnetic leakage within the motor, further reducing electromagnetic interference. This improvement not only enhances the motor's electromagnetic compatibility but also reduces electromagnetic noise generated during operation. These features contribute to lowering the overall noise levels of the blower. (b). This structural improvement also enhances the motor's thermal management and heat dissipation. The insulating material, despite being wrapped around the laminations, possesses excellent thermal conductivity. It facilitates the transfer of heat generated by the windings to the motor housing, which, combined with airflow cooling of the motor housing, improves the motor's heat dissipation efficiency. As a result, the motor's operational lifespan is extended. (c). The insulating material protects the laminations from adverse environmental conditions, reducing motor aging or performance degradation caused by such factors. This design also simplifies the motor's installation and maintenance processes by mitigating safety risks associated with exposed laminations. Consequently, it reduces the likelihood of motor failures and extends the motor's operational lifespan. Furthermore, the insulating material provides additional mechanical protection for the laminations, safeguarding them from physical impacts, vibrations, or other stresses. This contributes to maintaining the structural integrity and long-term reliability of the motor.

### BRIEF DESCRIPTION OF THE DRAWINGS

FIG. 1 is a three-dimensional schematic diagram of the blower in accordance with one embodiment of the present disclosure;

FIG. 2 is a schematic diagram of the blower housing including at least two parts in accordance with one embodiment of the present disclosure;

FIG. 3 is an exploded structural diagram of the blower in accordance with one embodiment of the present disclosure;

FIG. 4 is a schematic diagram of the regional division of the blower in accordance with one embodiment of the present disclosure;

FIG. 5 is a side view of the blower in accordance with one embodiment of the present disclosure;

FIGS. 6A, 6B and 6C are schematic diagrams showing the gas outlet of the blower configured in the second region;

FIG. 7 is a schematic diagram of the gas flow path within the gas passage illustrating the helical gas flow in the blower in accordance with one embodiment of the present disclosure;

FIG. 8 is a top view of the blower in accordance with one embodiment of the present disclosure;

FIG. 9 is a cross-sectional view of the blower taken along section A-A in FIG. 8 in accordance with one embodiment of the present disclosure;

FIG. 10 is a schematic diagram of the gas flow path within the blower in accordance with one embodiment of the present disclosure;

FIG. 11 is a three-dimensional cross-sectional view of the blower taken along section A-A in FIG. 8 in accordance with one embodiment of the present disclosure;

FIG. 12 is a three-dimensional schematic structural diagram of the blower in accordance with one embodiment of the present disclosure;

FIG. 13 is a schematic diagram showing the structure of the impeller and other components of the blower in accordance with one embodiment of the present disclosure;

FIG. 14 is a side view of the blower structure in accordance with one embodiment of the present disclosure;

FIG. 15 is a three-dimensional schematic diagram and a side view of the impeller in accordance with one embodiment of the present disclosure;

FIG. 16 is a schematic diagram of the gas flow path within the impeller channels in accordance with one embodiment of the present disclosure;

FIG. 17 is a side view of the blower structure in accordance with one embodiment of the present disclosure;

FIG. 18 is a schematic diagram of the gas flow path within the impeller channels in accordance with one embodiment of the present disclosure;

FIG. 19 is a schematic diagram showing the gas inlet of the blower constraining the central opening of the impeller in accordance with one embodiment of the present disclosure;

FIG. 20 is a three-dimensional schematic diagram of the motor and the impeller in accordance with one embodiment of the present disclosure;

FIG. 21 is a cross-sectional view of the motor and the impeller in accordance with one embodiment of the present disclosure;

FIG. 22 is a schematic diagram of the rotor assembly of the blower in accordance with one embodiment of the present disclosure;

FIG. 23 is a three-dimensional schematic diagram of the stator of the blower in accordance with one embodiment of the present disclosure;

FIG. 24 is a top view of the stator of the blower in accordance with one embodiment of the present disclosure;

FIG. 25 is a cross-sectional schematic diagram showing the insulating material wrapping around the laminations, taken along section B-B in FIG. 24 in accordance with one embodiment of the present disclosure;

FIG. 26 is a cross-sectional schematic diagram showing the insulating material wrapping around the laminations, taken along section C-C in FIG. 24 in accordance with one embodiment of the present disclosure;

FIG. 27 is a three-dimensional schematic diagram showing the insulating material wrapping around the laminations in accordance with one embodiment of the present disclosure.

### DETAILED DESCRIPTION

To facilitate understanding of the present disclosure, a detailed description is provided below with reference to the accompanying drawings. These drawings illustrate exemplary embodiments of the disclosure. However, the disclosure is not limited to the embodiments described herein and may be implemented in various forms. The purpose of the described embodiments is to provide a more thorough and comprehensive understanding of the disclosure.

Unless otherwise defined, all technical and scientific terms used herein have the same meanings as commonly understood by those skilled in the art to which the disclosure pertains. The terminology used in the description is intended to describe specific embodiments and is not intended to limit the scope of the disclosure.

The present disclosure addresses challenges associated with existing respiratory devices, such as the use of foam for noise reduction in ventilator blowers. Foam in these applications is prone to damage and aging, poses potential health and safety risks to users, involves complex manufacturing steps, and is less environmentally friendly. To overcome these issues, the disclosure provides a blower that is safer, more reliable, and easier to maintain. The blower disclosed herein not only addresses the shortcomings of existing blowers while ensuring compliance with regulatory noise level standards. This represents a better technical solution for users, manufacturers, and the market. Moreover, the substitution of traditional foam-based noise reduction with a resonance chamber structure inside the blower offers a sustainable and environmentally friendly design.

As used in this disclosure, “gas” broadly refers to any gaseous medium, including but not limited to air.

Detailed embodiments are presented below to elucidate several configurations of a blower with a gas pressurization system.

### Embodiment 1

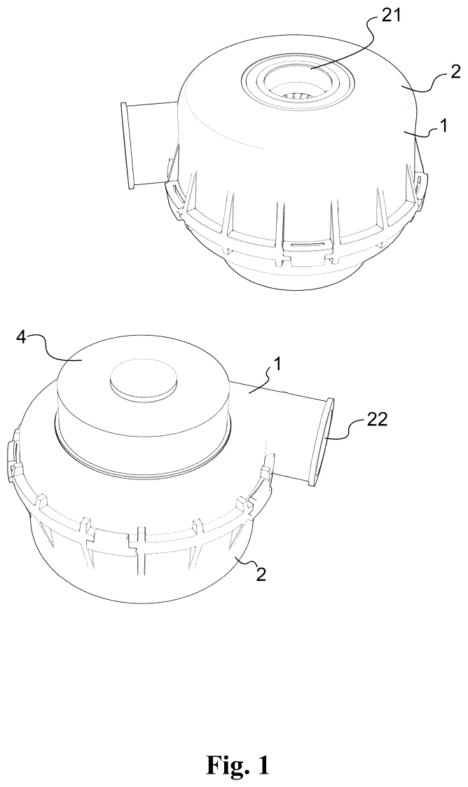

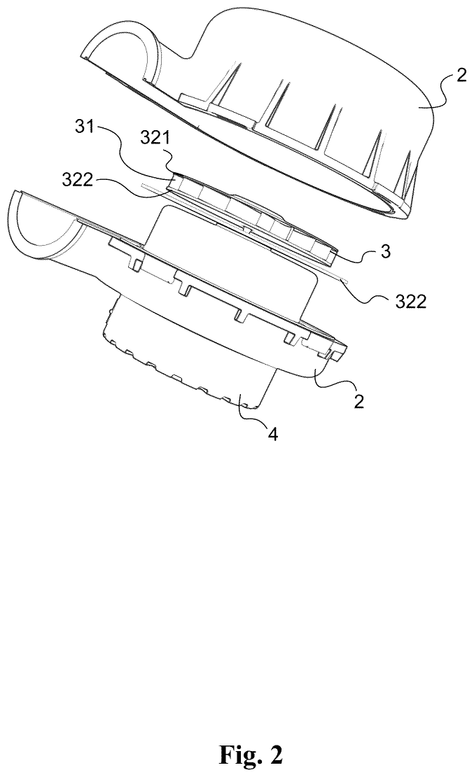

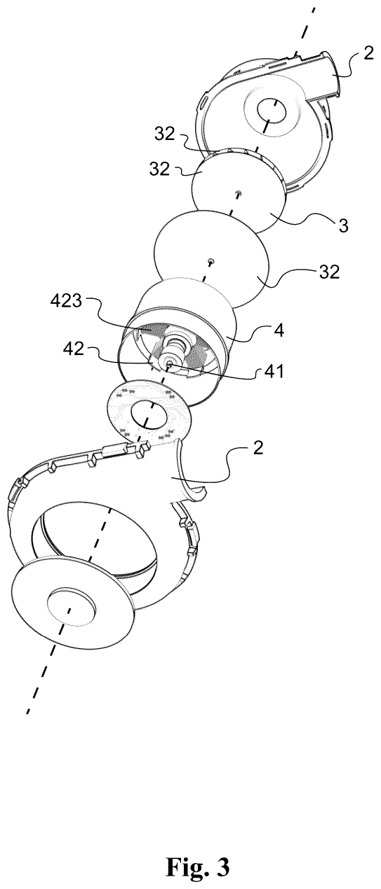

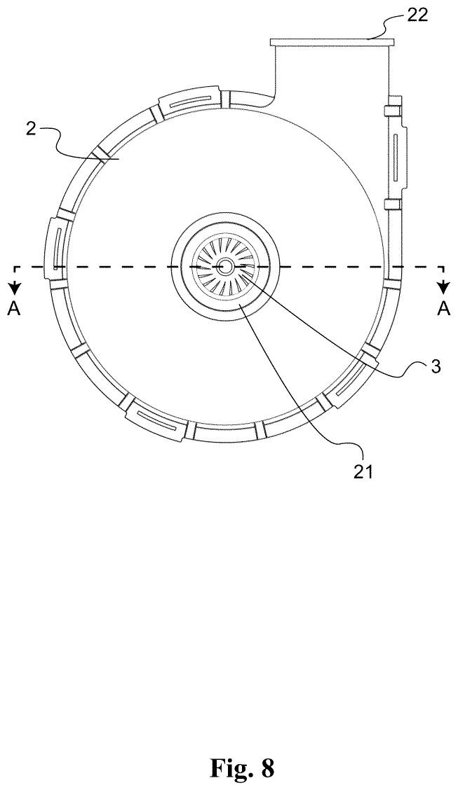

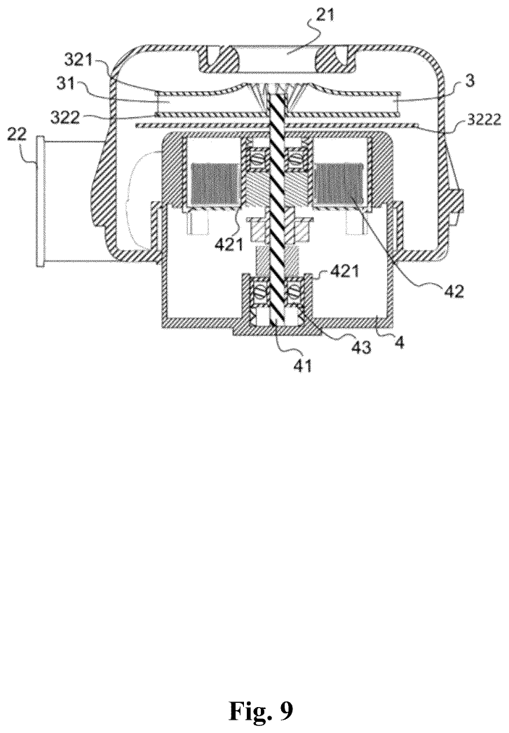

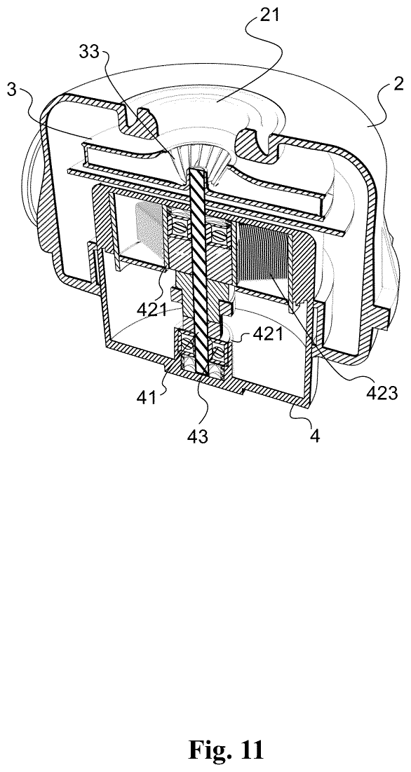

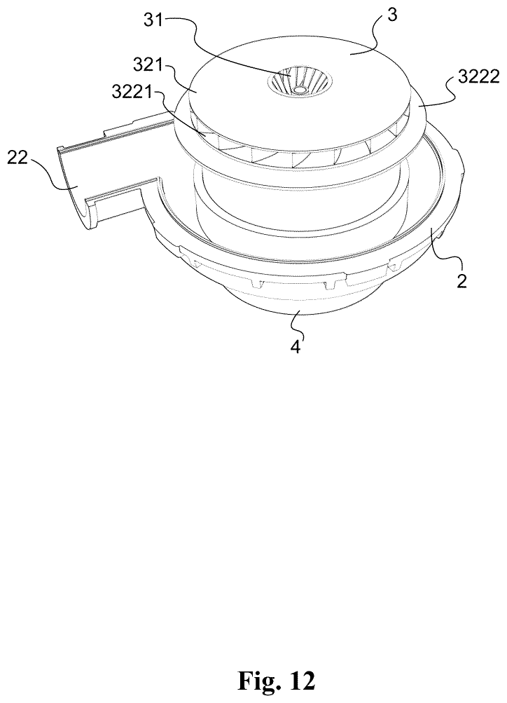

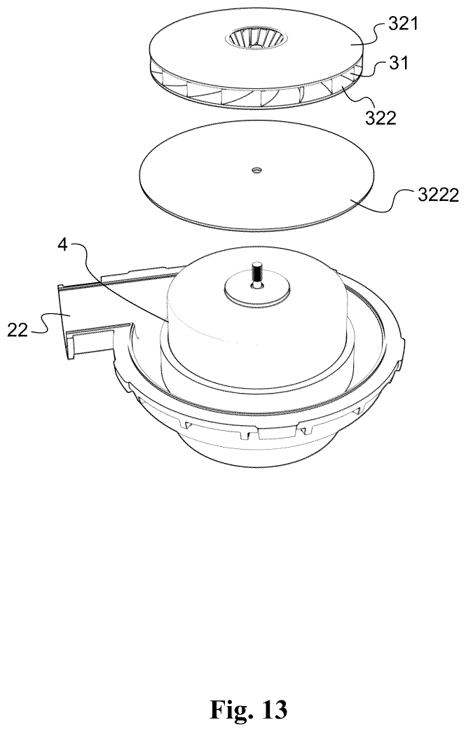

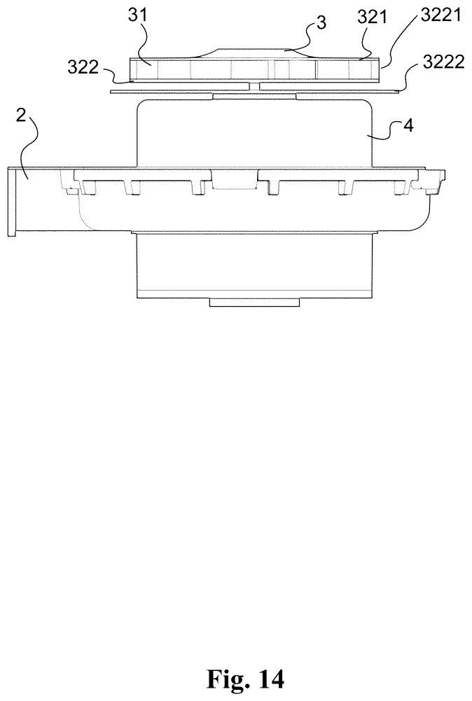

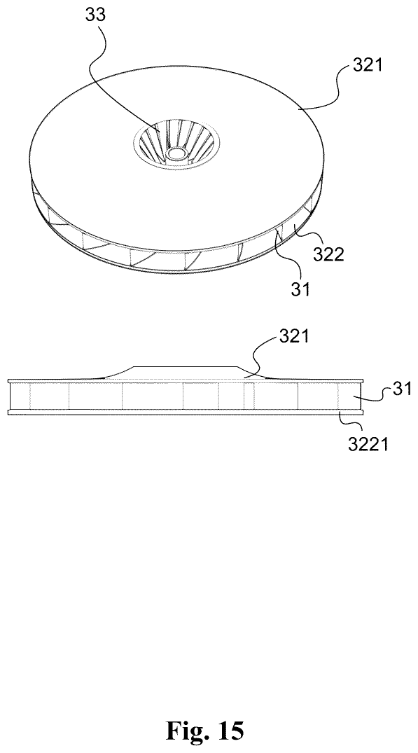

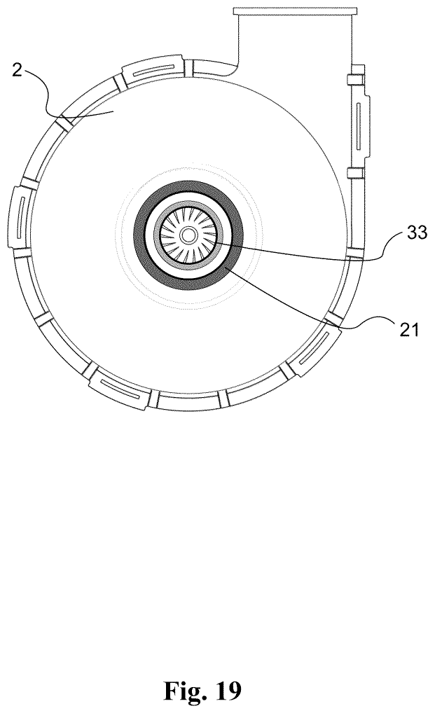

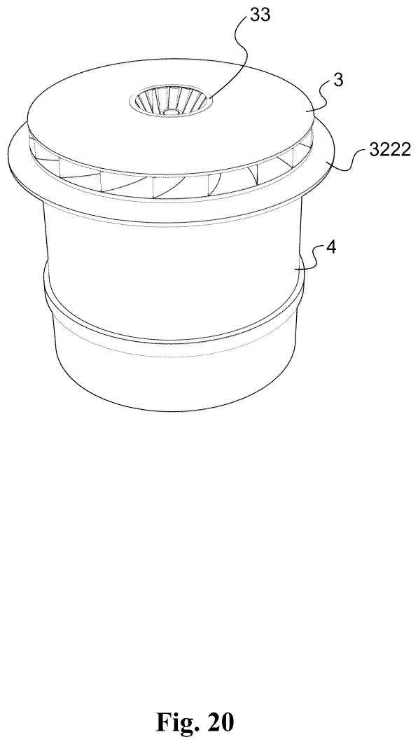

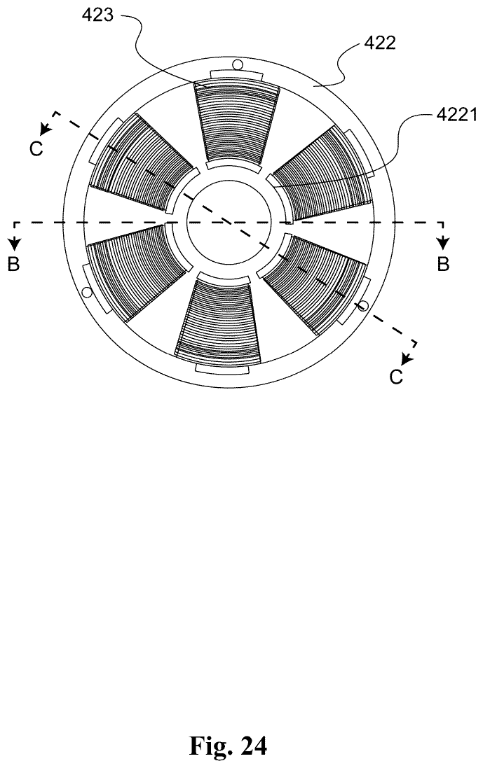

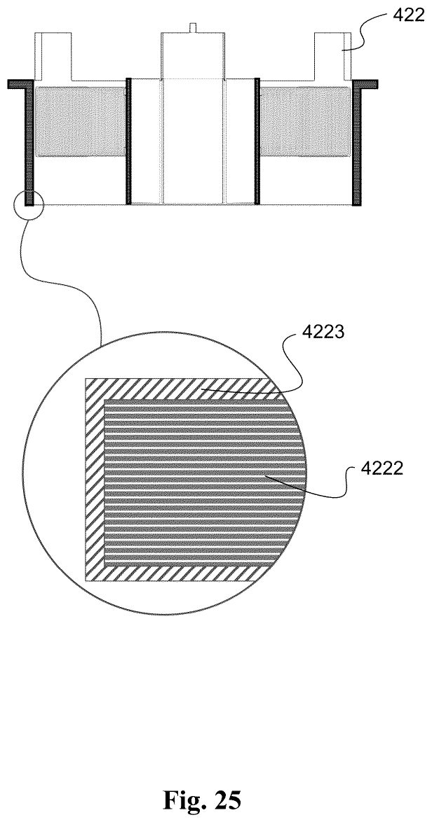

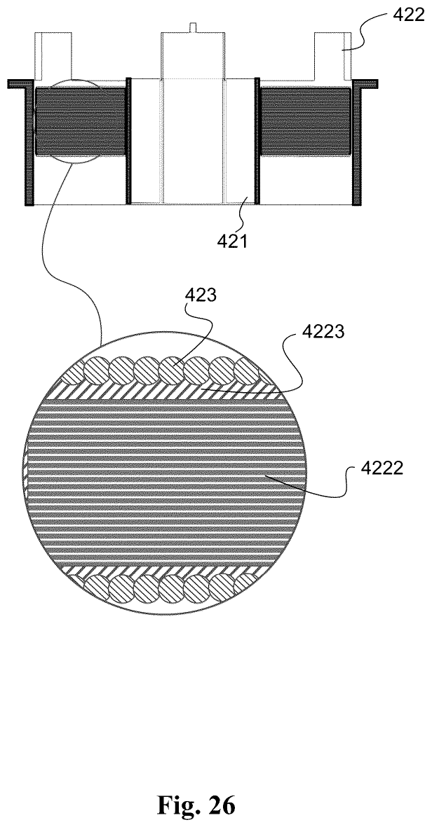

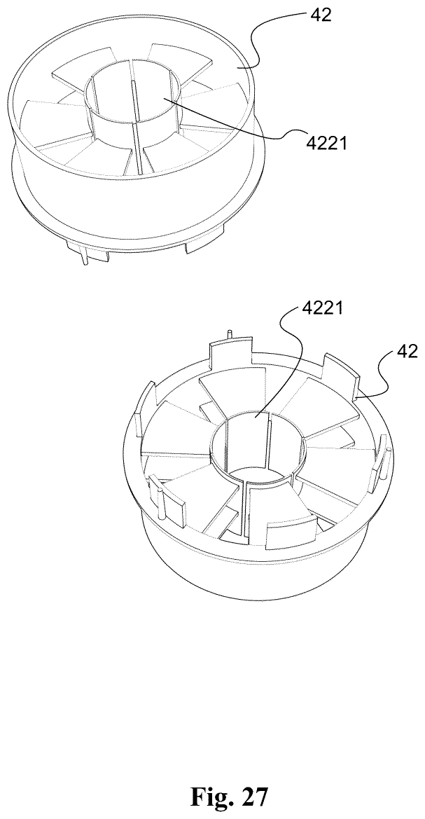

This embodiment provides a perspective schematic view, exploded view, cross-sectional view, side view, top view, gas flow diagram, and structural diagram of a blower 1, with reference to FIGS. 1-27. This embodiment relates to a blower 1 with a gas pressurization system, configured to pressurize gas to a range of 2 cmH₂O to 40 cmH₂O, and to deliver the pressurized gas to an outlet of a respiratory device. The blower 1 includes: a blower housing 2, configured to enclose the internal structure of the blower 1 and to form a gas passage for helical gas flow, the blower housing 2 including a gas inlet 21 and a gas outlet 22; an impeller 3, including a plurality of blades 31 and at least one casing 32, configured to accelerate the gas flow entering the blower 1 and to guide the gas flow radially; a brushless direct current (BLDC) motor 4, including a rotor assembly 41, a stator assembly 42, at least one permanent magnet, and bearings 43. The motor 4 has a first end 23 nearer the blower housing 2 and a second end 24 away from the blower housing 2. The impeller 3 is attached to the first end 23 of the motor 4 via the rotor assembly 41 and is driven by the motor 4.

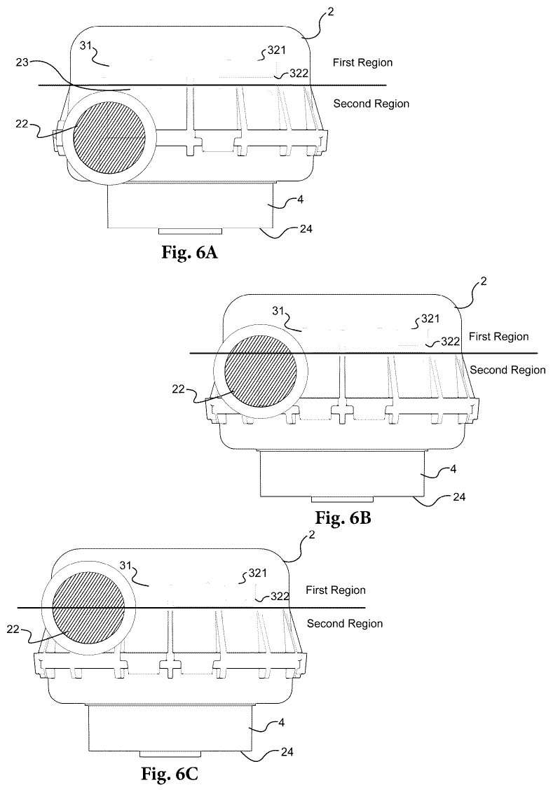

In this embodiment, the gas passage is divided by the impeller 3 into a first region above the impeller 3 and a second region below the impeller 3. Specifically, the bottom plane of the impeller 3 serves as the dividing line, and the space in the second region is larger than or equal to the space in the first region. In an orthogonal perspective along the axis of the gas outlet 22 of the blower, at least 50% of the gas outlet 22 is configured to be located in the second region, as illustrated in FIGS. 6A, 6B & 6C. FIGS. 6A, 6B & 6C respectively show examples where 100%, 75%, and 50% of the gas outlet 22 is configured to be located in the second region. This design shifts the gas passage in a direction away from the gas inlet 21 of the blower, causing the gas flow within the blower 1 to be positioned closer to the central part of the blower 1 (defined as within 20% above or below the midpoint of the blower 1). This reduces the noise of the blower 1, optimizes the gas flow path, and allows the gas flow to dissipate heat generated by the motor 4, preventing the motor 4 from ceasing operation due to excessive temperatures.

Specifically, the blower housing 2 is configured to include at least two parts, which are configured to join together to form a complete blower housing 2. The gas inlet 21 is located on one of these parts, and the axis of the gas inlet 21 is perpendicular to the axis of the gas outlet 22. The gas inlet 21 includes an arc-shaped chamfer, facilitating smoother entry of gas flow into the blower 1 and reducing noise. Compared to blower housings available on the market, the blower housing 2 of the present disclosure is taller and provides a larger internal space, which facilitates the organization of gas flow to reduce noise. In some special cases, the blower housing 2 may also consist of a single integrated structure configured to engage with the motor 4.

Except for the blower housing 2, the impeller and the brushless direct current motor are the internal structures of the blower 1. The blower 1 includes an impeller 3 positioned between the stator assembly 42 and the gas inlet 21 of the blower housing. The impeller 3 of the blower 1 includes a plurality of blades 31 and at least one casing 32. The at least one casing 32 includes at least an upper casing 321 and a lower casing 322, where the lower casing 322 includes a first sheet 3221 and a second sheet 3222. In the present disclosure, a sheet is defined as having a radius or a longer edge length that is at least five times its thickness. The impeller 3 is configured to accelerate the gas flow entering the blower 1 and to guide the gas flow radially through multiple channels within the impeller 3. The upper casing 321 and the first sheet 3221 of the lower casing 322 clamp the plurality of blades 31, forming the main body of the impeller 3. Having multiple casings, as opposed to a single casing, enables a relatively enclosed treatment of the channels within the impeller 3, reducing gas flow leakage and organizing the gas flow. This not only lowers the noise of the blower 1 but also enhances the structural stability and durability of the impeller 3. The second sheet 3222 is located below the first sheet 3221, with the first sheet 3221 and the second sheet 3222 coaxially aligned. The upper casing 321 and the lower casing 322 are also coaxially aligned. Additionally, the impeller 3 is coaxially aligned with the blower housing 2. In this embodiment, the second sheet 3222 is not connected to the first sheet 3221 and is configured to be positioned on the first end 23 of the motor 4, which is nearer the blower housing 2. The upper casing 321 is positioned nearer the gas inlet 21 of the blower housing 2, forming a central opening 33 in the impeller 3 that serves as the inlet to the impeller 3 channels. Furthermore, the upper casing 321 of the impeller 3 includes a protrusion at the central opening 33, configured to engage with the gas inlet 21 of the blower housing 2, ensuring smooth gas flow entry into the channels of the impeller 3. The protrusion is smoothly connectable to the main body of the upper casing 321 (i.e., the disc-shaped portion). The protrusion may take the form of a right conical shape, an inverted conical shape, or a cylindrical shape without taper. In certain cases, the upper casing 321 may also have a flat configuration without a protrusion. For blowers used in respiratory-related applications with noise reduction requirements, increasing the diameter of the central opening 33 of the blower 1 may reduce the effective diameter of the impeller 3, potentially resulting in insufficient pressure generation. However, reducing the diameter of the impeller 3 can help decrease the overall size of the blower 1, which contributes to improved portability and user comfort in respiratory devices. Smaller and quieter blowers are generally preferred for such applications. Reducing the diameter of the impeller 3 requires a proportional increase in the size of the central opening 33 of the impeller 3. Therefore, a balance must be achieved between these two parameters. In the present disclosure, the diameter of the central opening 33 is greater than 1.5% of the diameter of the main body of the impeller 3. In this embodiment, the upper casing 321 is non-flat and takes a curved right conical shape, specifically, the upper casing 321 gradually decreases in height downward in the radial direction relative to the axial direction.

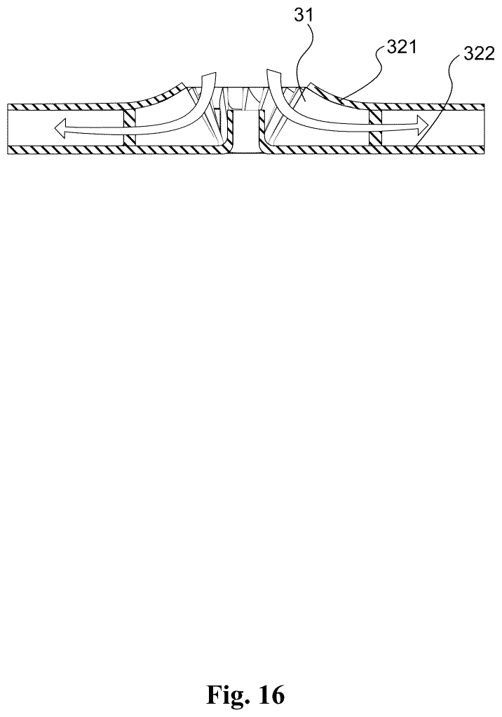

The central opening 33 formed by the upper casing 321 also defines the edges of the blades 31 at the central opening 33. Each blade 31 extends obliquely downward at the edge of the central opening 33 toward the lower casing 322, as shown in FIG. 16. The edge of each blade 31 at the central opening 33 forms an angle with the lower casing 322, where the angle is less than 90°. Under normal circumstances, the upper casing 321 extends radially from the central opening 33 to the periphery of the main body of the impeller 3. As a result, the diameter of the upper casing 321 is the same as the diameter of the main body of the impeller 3. In other cases, the upper casing 321 may not extend to the periphery of the main body of the impeller 3. One such example is where the upper casing 321 does not completely cover the entirety of the blades 31 but only partially covers the impeller 3. The blades 31 of the impeller 3 can take various forms, such as forward-curved, radial, or backward-curved. The length of the impeller 3 is greater than or equal to the difference between the diameter of the upper casing 321 and the diameter of the central opening 33 of the impeller 3. In this embodiment, the blades 31 gradually narrow near the central opening 33 and at the edges of the main body of the impeller 3, forming a spindle-like shape. In other embodiments, the blades 31 may have a uniform width or narrow on only one side.

The lower casing 322 of the impeller 3 is flat, with the first sheet 3221 forming a unified structure with the upper casing 321 and the plurality of blades 31. The edges of the first sheet 3221 align with the edges of the upper casing 321. In some other embodiments, the first sheet 3221 may be a disc with a diameter smaller or larger than that of the upper casing 321. In the main body of the impeller 3, formed by the upper casing 321, the blades 31, and the first sheet 3221, the upper casing 321 and the lower casing 322 clamp the plurality of blades 31, forming multiple impeller 3 channels. Specifically, each blade 31's side cooperates with the inner surface of the upper casing 321 and the inner surface of the first sheet 3221 to form the impeller 3 channels (as shown in FIG. 16). The impeller 3 includes a central opening 33, configured as the inlet for gas flow into the impeller 3 channels. Each impeller 3 channel expands radially from the inlet at the central opening 33 to the outlet near the edges of the upper casing 321 and the lower casing 322. That is, the distance between adjacent blades 31 gradually increases in the radial direction of the main body of the impeller 3. Additionally, each blade 31 decreases in height from the central opening 33 to the periphery of the impeller 3. Consequently, the impeller 3 channel narrows in a direction perpendicular to the gas flow from the inlet to the outlet. The inlet and outlet of each impeller 3 channel have a generally rectangular cross-sectional shape. To ensure that the gas flow entering through the gas inlet 21 on the blower housing 2 fully passes through the central opening 33 of the impeller 3, the sizes of the two openings are aligned with specific constraints. The gas inlet 21 of the blower 1 constrains the central opening 33 of the impeller 3, such that the area of the gas inlet 21 on the blower housing 2 is smaller than the area of the central opening 33 of the impeller 3.

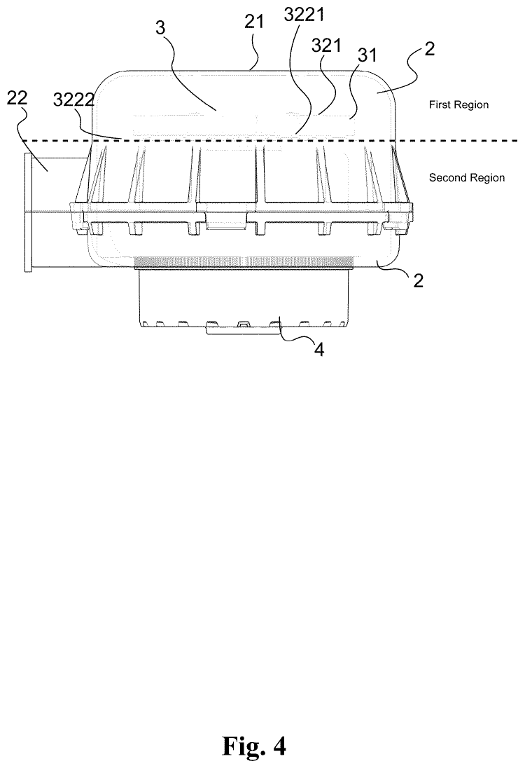

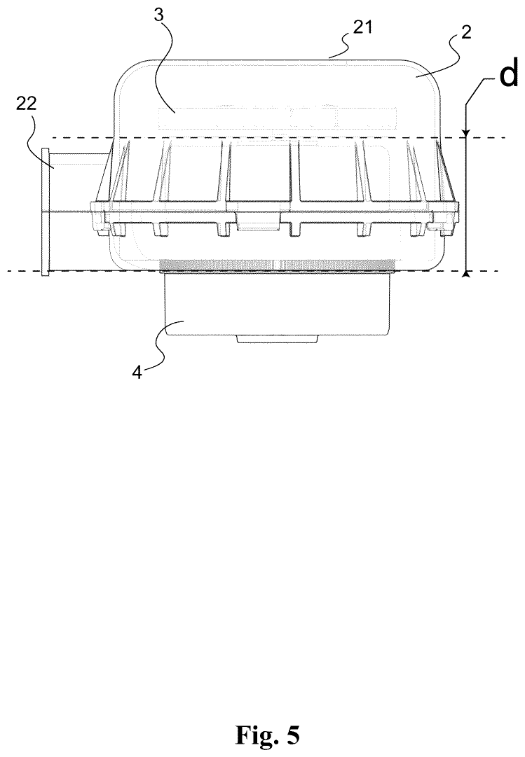

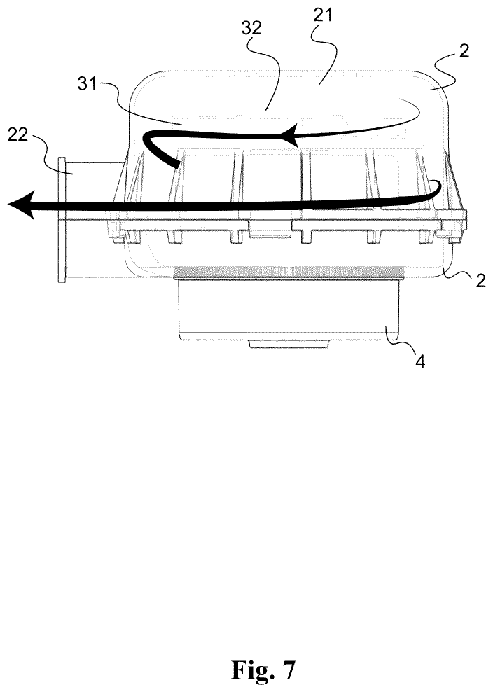

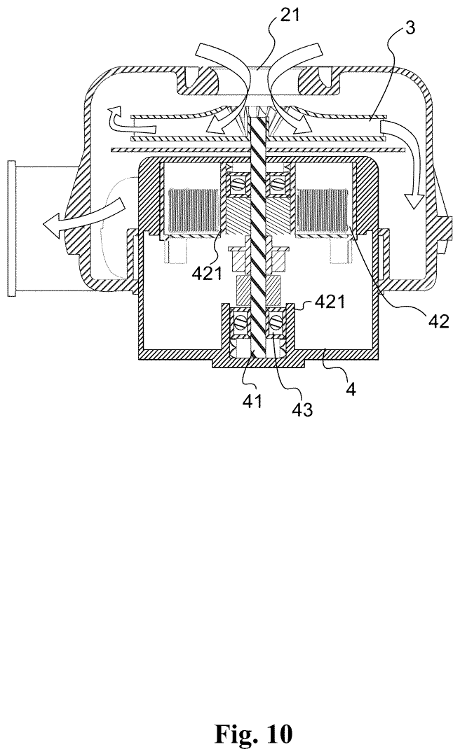

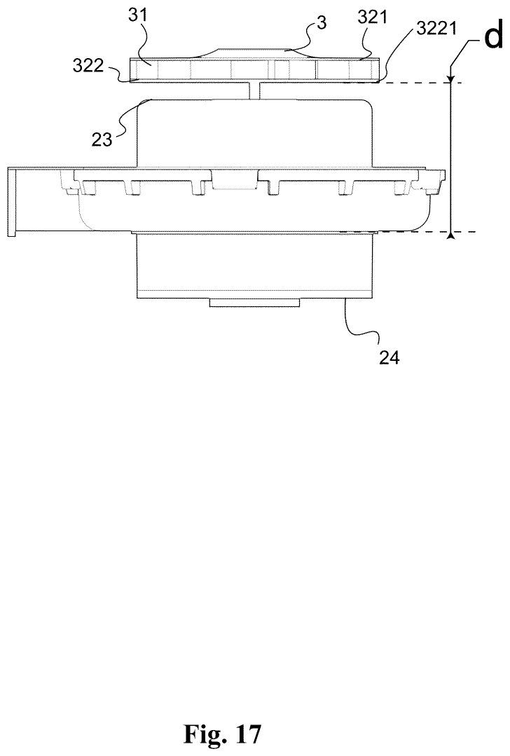

The second sheet 3222 in the impeller 3 plays a specialized role in the blower 1 by functionally partitioning the gas passage that provides a helical gas flow inside the blower 1. The diameter of the second sheet 3222 is greater than that of the first sheet 3221, serving to block the gas flow between the first region and the second region. Additionally, a gap is formed between the second sheet 3222 and the blower housing 2. This gap is evenly distributed along the periphery of the second sheet 3222 and is configured to allow the gas to flow evenly from the first region to the second region. In other cases, the gap between the second sheet 3222 and the blower housing 2 may be uneven. For instance, the gap may be formed only in a portion of the periphery of the second sheet 3222. Such a gap can take the shape of a crescent, spindle, square, or any other form. Therefore, the gas passage is divided by the impeller 3 into a first region above the impeller 3 and a second region below it. Specifically, the bottom plane of the impeller 3 serves as the dividing line (as shown in FIG. 4). The first region and the second region are configured such that gas flows through the gap formed between the second sheet 3222 and the blower housing 2. Gas flows at high velocity through the channels of the impeller 3 in the first region and subsequently enters the second region, where the gas flow is buffered. The high-velocity flow and buffering mentioned herein can be understood as differing gas flow velocities in the first region and the second region, with the gas flow velocity in the first region being higher than that in the second region. The gas flow process within the blower 1 involves external gas being drawn into the blower 1 through the gas inlet 21 of the blower housing 2. The gas then enters the impeller 3 channels through the central opening 33 and exits through the outlets of the impeller 3 channels. Due to the blocking effect of the second sheet 3222, the gas flow exiting the impeller 3 channels first flows through the first region, then passes through the gap between the periphery of the second sheet 3222 and the inner surface of the blower housing 2 into the second region, and finally exits through the volute tongue (as shown in FIGS. 7 and 10). The motor 4 applies a strong rotational force to at least the main body of the impeller 3 via the rotor assembly 41, generating high gas flow velocity. The separation between the first region and the second region creates a pressure differential, causing the high-velocity, low-pressure gas in the first region to naturally flow into the second region. When the high-velocity, low-pressure gas from the first region enters the second region, the gas flow velocity decreases, and the pressure increases. Moreover, the space in the second region is larger than or equal to the space in the first region, which promotes an increase in gas flow pressure. Consequently, the blower 1 of the present disclosure can generate higher gas flow pressure compared to conventional blowers available on the market. In certain special configurations of gas passages of the blower 1, the space in the second region may be smaller than that in the first region. In this embodiment, the size of the second region is specifically defined, where the vertical distance between a lowest plane of the second region away from the impeller and the impeller 3 is greater than or equal to 10 mm (as shown in FIGS. 5 and 17). In other embodiments, this distance may vary depending on the overall size of the blower 1, for example, 8 mm or smaller. The second sheet 3222 is configured to have a thickness similar to that of the first sheet 3221. In this embodiment, the thickness ratio between the first sheet 3221 and the second sheet 3222 ranges from 0.7 to 1.3.

The blower housing 2 and the impeller 3 may be made of the same material or different materials. Additionally, the second sheet 3222 and the main body of the impeller 3 can be integrally formed or non-integrally formed. In this embodiment, the second sheet 3222 is separate from the first sheet 3221, with an axial gap between them. The impeller 3 can also be molded using one or multiple materials.

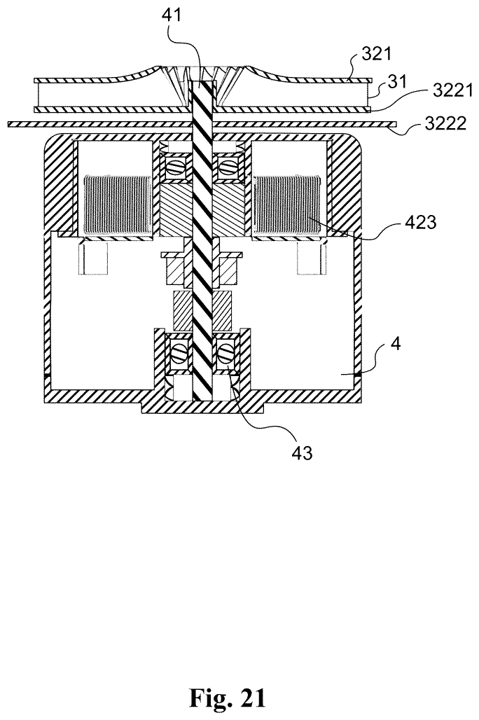

The motor 4 includes a rotor assembly 41, a stator assembly 42, at least one permanent magnet, and bearings 43 (as shown in FIG. 21). Preferably, the motor 4 of the present disclosure uses an electronic commutator (also referred to as a microcontroller) to control the switching of current in the coils 423, enabling the continuous rotation of the rotor assembly 41. Compared to a brushless alternating current (AC) motor, a brushless direct current (BLDC) motor 4 has a control system that is easier to implement. Therefore, in the present disclosure, when variables such as speed, torque, or position need to be controlled, the BLDC motor 4 is typically used to drive the blower 1. The BLDC motor 4 in the present disclosure is characterized by its high efficiency, extended lifespan, low noise, high stability, reduced maintenance requirements, precise control, and compact design, making it an optimal choice for household ventilators. The basic working principle is as follows: One or more stator phases are energized, and the current flowing through the coils 423 generates a magnetic field, which aligns the rotor assembly 41 with the magnetic field. By sequentially applying voltage to different stator phases, the rotor assembly 41 rotates by a specific angle and ultimately reaches the desired position. The rotor assembly 41 includes at least one permanent magnet made of high-energy-density magnetic material, which provides a strong and constant magnetic field. The stator 422 includes windings, typically constructed from copper wires with good electrical conductivity and low resistance to ensure efficient current flow and minimize energy losses. In the BLDC motor 4, the at least one permanent magnet produces a constant magnetic field that interacts with the electromagnetic field generated by the stator windings to produce torque, driving the rotation of the rotor assembly 41. In this embodiment, the rotor assembly 41 may be surrounded by the windings. In other embodiments, the rotor assembly 41 may also be positioned outside the windings, in which case it is referred to as an “outer rotor” BLDC motor 4.

The motor 4 can also have different numbers of windings. The most common configuration is a three-phase BLDC motor 4. In other devices, such as small cooling fans, the BLDC motor 4 may have only one or two phases. The motor's three windings are typically connected in either a “star” or a “delta” configuration.

In particular, the stator assembly 42 includes a stator assembly housing, which is exposed to the gas passage providing a helical gas flow. The stator assembly housing is configured to reduce the temperature of the stator assembly 42 as the gas flow passes through the gas passage. Specifically, the outer surface of the stator assembly housing 42 is at least partially exposed to the gas passage and is configured to allow convective cooling of the stator assembly 42 during the operation of the blower 1. Convective cooling occurs as gas flow within the gas passage flows over the stator assembly 42, removing part of its heat (as shown in FIGS. 7, 10, and 14). Additionally, the stator assembly 42 is exposed both to the gas passage inside the blower 1 and to the external environment outside the blower housing 2. The “external environment” here refers to spaces outside the gas passage that provides the helical gas flow inside the blower 1. The motor housing encloses various motor components internally and is externally connected to and fixed to the blower housing 2. The motor housing is in a sealed configuration, such that gas flow within the gas passage of the blower housing 2 does not flow through the interior of the stator assembly 42. The motor housing includes a flange that supports the blower housing 2. Inside the housing of the motor 4, a non-integral tube 421 is configured between the rotor assembly 41 and the stator assembly 42. In this embodiment, the non-integral tube 421 is constructed with two parts, the two parts being separated with a gap inside the blower 1. Each part is rotatably configured to support the bearings 43 inside the motor 4, with dimensions specifically designed to accommodate the bearings 43. The dimensions of the upper and lower portions of the tube 421 can be either identical or different. In certain cases, the tube 421 may also be designed as an integral structure. The rotor assembly 41 and the stator assembly 42 are coaxially aligned, and no gas gap is formed between them. The rotor assembly 41 is tightly fitted to the tube 421.

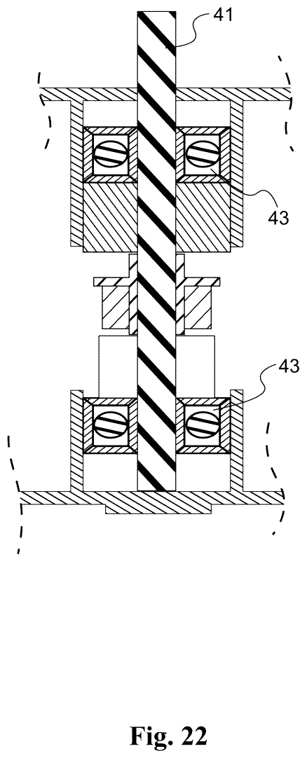

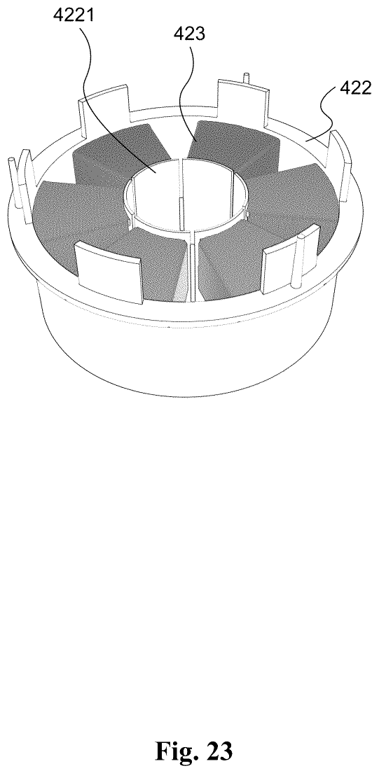

The rotor assembly 41 includes an integrated shaft, which is connectable to the impeller 3 via a metal component attached to the shaft. Specifically, the rotor assembly 41 includes a metal component that is in contact with and securely clamped to the impeller 3 (as shown in FIG. 22). In some other cases, the shaft of the rotor assembly 41 may consist of two separate parts. In this embodiment, the stator assembly 42 includes a stator 422 with a central hole and multiple coils 423 arranged in a distributed winding configuration. The coils 423 are grouped into phase coil groups for each phase of the multi-phase switched reluctance BLDC motor 4. The stator 422 further includes multiple protruding stator teeth 4221. The stator 422 is composed of multiple laminations 4222 and insulating materials 4223 that wrap around the laminations 4222. The insulating material 4223 is attached to the surface of the lamination assembly 4222 to insulate the laminations 4222 from the windings (as shown in FIGS. 23-27). In certain cases, the insulating material 4223 may be formed as one or more parts, either integrated with or separate from the laminations 4222. The insulating material 4223 includes, but is not limited to, polytetrafluoroethylene (PTFE), polyimide (PI), epoxy resin, silicone rubber, polyvinyl chloride (PVC), polyester (PET), nylon, polycarbonate (PC), and polyurethane (PU). These materials are electrically insulating, thermally resistant, chemically stable, and corrosion-resistant, effectively shielding electrical components from environmental factors and ensuring safer and longer-lasting operation of the device.

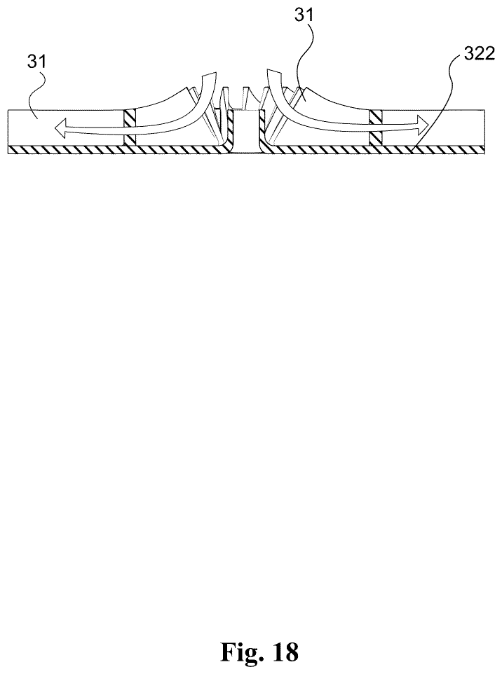

In some embodiments, the impeller 3 may not include the upper casing 321 (as shown in FIG. 18).

In some embodiments, the impeller 3 may not include the second sheet 3222 (as shown in FIG. 17).

### Embodiment 2

This embodiment relates to a blower 1 configured with a pressurization system to pressurize gas to a range of 2 cmH₂O to 40 cmH₂O and deliver it to the outlet of a respiratory device. The blower 1 includes: a blower housing 2, configured to enclose the internal structure of the blower 1 and form a gas passage for helical gas flow. The blower housing 2 includes a gas inlet 21 and a gas outlet 22; an impeller 3, including a plurality of blades 31 and at least one casing 32, configured to accelerate the gas flow entering the blower 1 and guide the gas flow radially; a brushless direct current (BLDC) motor 4, including a rotor assembly 41, a stator assembly 42, at least one permanent magnet, and bearings 43. The motor 4 has a first end 23 nearer the blower housing 2 and a second end 24 away from the blower housing 2. The impeller 3 is attached to the first end 23 of the motor 4 via the rotor assembly 41 and is driven by the motor 4.

The gas passage is divided by the impeller 3 into a first region above the impeller 3 and a second region below the impeller 3. The space in the second region is larger than or equal to the space in the first region.

In this embodiment, the primary difference from the blower 1 in Embodiment 1 is the addition of a Hall sensor. The Hall sensor enables precise, real-time monitoring of the rotational speed of the blower 1, ensuring it operates within the preset speed range and providing an additional layer of protection compared to conventional designs.

The Hall sensor also delivers real-time feedback, allowing operators to precisely control parameters such as speed and gas flow. This enhances the blower's adaptability to different environments and operational requirements, improving overall reliability. Additionally, by preventing overoperation, the Hall sensor reduces wear on internal components, lowering maintenance frequency and costs over the lifespan of the blower 1.

Moreover, it is possible to combine the technical features from each of the above embodiments as needed to obtain a blower 1 that includes all or some of these features.

Implementing the blower 1 of the present disclosure has at least the following beneficial effects:
1. To enhance the noise-reducing performance of the blower, reduce the impact of respiratory devices on users, and improve user comfort, the structure of the blower and its components have been comprehensively improved, tested, and continuously optimized. These efforts have resulted in a blower that offers reduced noise levels and improved comfort compared to products currently available on the market. Initially, the internal gas passage of the blower housing was relocated downward relative to the impeller, and its spatial configuration was optimized. This was combined with a unique impeller partitioning design to refine the internal gas flow path of the blower. On this basis, the impeller was replaced with a quieter and more efficient closed impeller, which includes an upper casing and a lower casing. Additionally, a uniquely structured motor design was implemented to achieve better matching between the impeller and the motor. The optimized impeller and motor pairing, along with the improved gas passage inside the blower housing to provide helical gas flow, resulted in significant overall enhancements. These improvements contribute to a blower design that offers increased benefits for users. The enhancements not only improve the noise-reducing performance of the device but also provide practical advantages for users, leading to notable improvements in overall product performance and user experience.
2. Designing the impeller with multiple casings offers several advantages. (a). The impeller includes an upper casing and a lower casing that clamp multiple blades between them, forming more enclosed impeller channels. These enclosed channels reduce gas leakage from the sides of the impeller and effectively guide the gas flow along optimized paths. This ensures smoother gas flow through the impeller, reduces turbulence and energy loss, and results in higher efficiency compared to open and semi-open impellers, typically achieving an efficiency increase of 1-3% over semi-open impellers. Additionally, this design improves the overall sealing performance of the blower, reducing gas backflow losses and further enhancing the blowers' efficiency and performance. (b). The upper casing and the lower casing provide better guidance for the gas flow, ensuring smoother flow within the impeller. This reduces the formation of vortices and turbulence, thereby lowering the likelihood of noise generation. Moreover, the impeller in this disclosure has greater rigidity, leading to reduced vibration during blower operation. Its robust and symmetrical structure enhances balance and stability, further contributing to noise reduction and ensuring more stable operation. (c). The impeller in this disclosure maintains stable performance under relatively higher gas pressures. This stability is primarily due to the structural design of the upper casing and the lower casing, which enhances resistance to pressure and deformation. This ensures reduced pressure fluctuations and stable operation under high-pressure conditions. Such advantages are particularly significant for ventilators that require frequent pressure adjustments during operation. The impeller's ability to adapt to varying gas pressures makes it an ideal choice for ventilators, extending the device's lifespan and ensuring reliable performance over time.
3. The addition of the second sheet divides the previously unified internal gas passage for helical gas flow into two separate regions. This division offers multiple advantages that are unattainable with traditional blower designs. In conventional blower designs, gas is drawn in through the inlet, accelerated by the impeller, and directly expelled through the outlet. The gas passage is relatively short, and high-velocity gas exiting the impeller flows directly to the housing edge or the volute tongue. This limited space often causes turbulence as the gas enters the volute tongue, reducing the blower's efficiency. Furthermore, turbulence at the impeller edge and the volute tongue generates additional noise. In this disclosure, a second sheet is provided below the first sheet of the impeller. The inclusion of the second sheet enables the high-velocity gas exiting the impeller channels to transition more smoothly as it moves from the first region to the volute tongue (i.e., through the second region). This design reduces the impact of the gas flow. In the first region, gas flows at high velocity, while the uniform gap between the second sheet and the inner surface of the blower housing allows gas to transition evenly into the second region below. This design eliminates (or significantly reduces) turbulence caused by flow separation at the impeller edge and volute tongue, improving blower performance and reducing noise. Additionally, the space in the second region is larger than or equal to the space in the first region. When the space in the second region is larger than the space in the first region, as the gas flows from the first region into the second region, the increased volume slows the gas velocity and increases gas pressure. The reduced velocity not only decreases turbulence but also enables this blower to operate across a wider pressure range while noticeably lowering noise levels compared to traditional blowers. The diameter of the second sheet is greater than that of the first sheet, which helps prevent gas backflow, reduce noise, and enhance the blower's overall performance and noise-reduction capabilities. Dividing the gas passage into two regions also extends the gas passage, reducing flow impact, lowering noise levels, and improving efficiency.
4. Lowering the gas passage to the central position of the blower provides the following advantages. (a). By positioning the gas passage at the central part of the blower, the gas flow entering the blower passes over the motor, carrying away the heat generated during motor operation. This assists in motor cooling, maintaining the motor within an appropriate temperature range, and prevents overheating caused by prolonged use. As a result, the motor's operational efficiency and lifespan are improved, which in turn enhances the overall efficiency and durability of the blower. (b). In conventional blower designs available in the market, the gas passage is positioned near the impeller. In these designs, the pressurized gas exiting the impeller immediately enters the gas passage and is discharged. This abrupt transition results in sudden, rapid changes in the gas flow, which can cause turbulence or irregular flow patterns, increasing the blower's noise levels. Additionally, the sudden changes may induce fluctuations in the gas flow, further contributing to noise problems. In contrast, lowering the gas passage to the central position of the blower provides a buffering space for the pressurized gas flow. This design allows the gas flow to transition more smoothly and uniformly along the gas passage, reducing turbulence and irregular flow within the blower, thereby reducing noise. (c). By integrating the functionality of the second sheet, the originally unified gas passage designed for helical gas flow is divided into a flow path from the first region to the second region. Lowering the gas passage expands the previously limited space, allowing the second sheet to fully perform its intended function and create a more optimized flow path. With the gas passage lowered, the airflow in the second region transitions more gradually, avoiding abrupt changes caused by spatial constraints. This design reduces turbulence formation and lowers the blower's noise levels. Moreover, this improvement enhances the aerodynamic performance of the entire gas passage, improving both the efficiency and stability of the blower. The noise-reducing capabilities of the second sheet are further amplified through this design, resulting in quieter and more efficient blower operation. (d). When the blower uses a closed impeller, it differs from non-closed impellers in that its blades are enclosed within a casing. The closed impeller has a central opening through which the gas enters, passing through impeller channels formed by the blades. This design allows the pressurized airflow to be discharged from the enclosed structure at a higher pressure. In contrast, non-closed impellers have a more open structure, which permits airflow to move freely on both sides of the impeller without significant path restrictions. As a result, blowers with closed impellers require the gas passage to be lowered, providing additional space for the pressurized airflow to be guided more effectively. This enhances the performance and efficiency of the blower. (e). In addition, designing the gas passage at the central position of the blower contributes to improved stability when integrated into respiratory devices. In conventional blower designs, the internal gas passage is typically positioned near the top of the blower. However, in this disclosure, the gas passage is shifted downward, resulting in the overall center of gravity being closer to the central position of the blower. This adjustment reduces mechanical vibrations caused by changes in airflow pressure and velocity, improving operational stability and safety. Furthermore, this design allows the blower to be more securely mounted within respiratory devices, reducing wobbling and ensuring a stable installation, further mitigating motor noise caused by vibrations.
5. The motor has been improved with a key enhancement involving the use of insulating material to wrap the laminations, ensuring that the coils do not come into direct contact with the laminations. This design offers several advantages: (a). The insulating material wrapped around the laminations strengthens the motor's electrical insulation and reduces electromagnetic interference. It effectively prevents electrical short circuits between the laminations and other motor components, avoiding unintended current flow between windings or between the windings and the motor housing. Additionally, it suppresses magnetic leakage within the motor, further reducing electromagnetic interference. This improvement not only enhances the motor's electromagnetic compatibility but also reduces electromagnetic noise generated during operation. These features contribute to lowering the overall noise levels of the blower. (b). This structural improvement also enhances the motor's thermal management and heat dissipation. The insulating material, despite being wrapped around the laminations, possesses excellent thermal conductivity. It facilitates the transfer of heat generated by the windings to the motor housing, which, combined with airflow cooling of the motor housing, improves the motor's heat dissipation efficiency. As a result, the motor's operational lifespan is extended. (c). The insulating material protects the laminations from adverse environmental conditions, reducing motor aging or performance degradation caused by such factors. This design also simplifies the motor's installation and maintenance processes by mitigating safety risks associated with exposed laminations. Consequently, it reduces the likelihood of motor failures and extends the motor's operational lifespan. Furthermore, the insulating material provides additional mechanical protection for the laminations, safeguarding them from physical impacts, vibrations, or other stresses. This contributes to maintaining the structural integrity and long-term reliability of the motor.

The above description of the embodiments of the disclosure is provided with reference to the accompanying drawings. However, the disclosure is not limited to the specific embodiments described above. These specific embodiments are merely illustrative and not restrictive. Those skilled in the art, in light of the teachings of the disclosure, may make many modifications and variations without departing from the spirit and scope of the disclosure as defined by the claims. All such modifications and variations are within the protection scope of the disclosure.

It must be noted that as used herein and in the appended claims, the singular forms “a”, “an”, and “the” include their plural equivalents, unless the context clearly dictates otherwise.

1. A blower with a gas pressurization system, configured to pressurize gas to a range of 2 cmH₂O to 40 cmH₂O and deliver pressurized gas to an outlet of a respiratory device, comprising:
a blower housing, configured to enclose an internal structure of the blower and form a gas passage for helical gas flow, the blower housing including a gas inlet and a gas outlet;
an impeller, comprising a plurality of blades and at least one casing, configured to accelerate the gas flow entering the blower and guide the gas flow radially, the impeller having a planar bottom end;
a brushless direct current motor, comprising a rotor assembly, a stator assembly, at least one permanent magnet, and bearings, the motor having a first end nearer the blower housing and a second end away from the blower housing, wherein the impeller is attached to the first end of the motor via the rotor assembly and is driven by the motor;
wherein the impeller is positioned on a same side of the motor as the gas inlet,
one side of the gas inlet is provided in an external environment, and the other side of the gas inlet is provided above the impeller,
wherein an outer side surface of the blower housing is exposed to the external environment,
wherein the gas passage is divided by the impeller into a first region above the impeller and a second region below the impeller, a space in the second region being larger than or equal to a space in the first region,
wherein at least 50% of the gas outlet is configured to be located in the second region, and
wherein a vertical distance between a lowest plane of the second region away from the impeller and the impeller is greater than or equal to 10 mm.

2. The blower according to claim 1, wherein the blower housing comprises at least two parts that are configured to join together to form a complete blower housing.

3. The blower according to claim 1, wherein the stator assembly includes a stator assembly housing, the stator assembly housing being exposed to the gas passage, the gas passage being configured to reduce a temperature of the stator assembly as the gas flow passes through the gas passage.

4. The blower according to claim 3, wherein the stator assembly is exposed both to the gas passage inside the blower and to an external environment outside the blower housing.

5. The blower according to claim 1, wherein the impeller includes a central opening, and the gas inlet of the blower is configured to constrain the central opening of the impeller.

6. The blower according to claim 1, wherein the impeller is coaxially aligned with the blower housing.

7. A blower with a gas pressurization system, configured to pressurize gas to a range of 2 cmH₂O to 40 cmH₂O and deliver pressurized gas to an outlet of a respiratory device, comprising:
a blower housing, configured to enclose an internal structure of the blower and form a gas passage for helical gas flow, the blower housing including a gas inlet and a gas outlet;
an impeller, comprising a plurality of blades and at least one casing, wherein the at least one casing at least includes an upper casing and a lower casing, wherein the upper casing and the lower casing are configured to clamp the plurality of blades and form multiple impeller channels, wherein the impeller is configured to accelerate the gas flow entering the blower and guide the gas flow radially through the multiple impeller channels, and wherein the impeller has a planar bottom end;
a brushless direct current motor, comprising a rotor assembly, a stator assembly, at least one permanent magnet, and bearings, the motor having a first end nearer the blower housing and a second end away from the blower housing, wherein the impeller is attached to the first end of the motor via the rotor assembly and is driven by the motor;
wherein the impeller is positioned on a same side of the motor as the gas inlet,
one side of the gas inlet is provided in external environment, and the other side of the gas inlet is provided above the impeller,
wherein the gas passage is divided by the impeller into a first region above the impeller and a second region below the impeller, a space in the second region being larger than or equal to a space in the first region, and
wherein at least 50% of the gas outlet is configured to be located in the second region.

8. The blower according to claim 7, wherein the upper casing of the impeller includes a protrusion at a central opening.

9. The blower according to claim 7, wherein the upper casing gradually decreases in height downward in a radial direction relative to an axial direction.

10. The blower according to claim 7, wherein the impeller includes a central opening configured to be an inlet for the gas flow into the impeller channels, and each blade decreases in height from the central opening to the periphery of the impeller.

11. The blower according to claim 10, wherein an edge of each blade at the central opening forms an angle with the lower casing, the angle being less than 90°.

12. The blower according to claim 7, wherein a vertical distance between a lowest plane of the second region away from the impeller and the lower casing is greater than or equal to 10 mm.

13. A blower with a gas pressurization system, configured to pressurize gas to a range of 2 cmH₂O to 40 cmH₂O and deliver pressurized gas to an outlet of a respiratory device, comprising:
a blower housing, configured to enclose an internal structure of the blower and form a gas passage for helical gas flow, the blower housing including a gas inlet and a gas outlet;
an impeller, comprising a plurality of blades and at least one casing, wherein the at least one casing at least includes an upper casing and a lower casing, wherein the upper casing and the lower casing are configured to clamp the plurality of blades and form multiple impeller channels, wherein the impeller is configured to accelerate the gas flow entering the blower and guide the gas flow radially through the multiple impeller channels;
a brushless direct current motor, comprising a rotor assembly, a stator assembly, at least one permanent magnet, and bearings, the motor having a first end nearer the blower housing and a second end away from the blower housing, wherein the impeller is attached to the first end of the motor via the rotor assembly and is driven by the motor;
wherein the impeller is positioned on a same side of the motor as the gas inlet,
one side of the gas inlet is provided in an external environment, and the other side of the gas inlet is provided above the impeller,
wherein an outer side surface of the blower housing is exposed to the external environment,
wherein the lower casing includes a first sheet and a second sheet, the first sheet and the second sheet being coaxially aligned, the first sheet and the second sheet being vertically spaced apart, and a diameter of the second sheet being greater than a diameter of the first sheet;
wherein the gas passage is divided by the impeller into a first region above the impeller and a second region below the impeller, wherein the first region and the second region are configured such that the gas flows through a gap formed between the second sheet and the blower housing, and
wherein the gas flows at high velocity through the impeller channels in the first region and subsequently enters the second region where the gas flow is buffered.

14. The blower according to claim 13, wherein a diameter of the second sheet is greater than a diameter of the first sheet.

15. The blower according to claim 13, wherein the gap formed between the second sheet and the blower housing is uniformly distributed along a periphery of the second sheet and is configured to allow the gas to flow evenly from the first region to the second region.

16. The blower according to claim 13, wherein a thickness ratio of the first sheet to the second sheet ranges from 0.7 to 1.3.

17. The blower according to claim 13, wherein a space in the second region is larger than or equal to a space in the first region.

18. The blower according to claim 13, wherein a space in the second region is smaller than a space in the first region.

19. A blower with a gas pressurization system, configured to pressurize gas to a range of 2 cmH₂O to 40 cmH₂O and deliver pressurized gas to an outlet of a respiratory device, comprising:
a blower housing, configured to enclose an internal structure of the blower and form a gas passage for helical gas flow, the blower housing including a gas inlet and a gas outlet;
an impeller, comprising a plurality of blades and at least one casing, configured to accelerate the gas flow entering the blower and guide the gas flow radially, the impeller having a planar bottom end;
a brushless direct current motor, comprising a rotor assembly, a stator assembly, at least one permanent magnet, and bearings, the motor having a first end nearer the blower housing and a second end away from the blower housing, wherein the impeller is attached to the first end of the motor via the rotor assembly and is driven by the motor;
wherein the impeller is positioned on a same side of the motor as the gas inlet,
one side of the gas inlet is provided in an external environment, and the other side of the gas inlet is provided above the impeller,
wherein an outer side surface of the blower housing is exposed to the external environment,
wherein the stator assembly includes a stator assembly housing, an outer surface of the stator assembly housing being at least partially exposed to the gas passage and configured to allow convective cooling of the stator assembly during operation of the blower,
wherein a non-integral tube is provided between the rotor assembly and the stator assembly,
wherein the stator assembly includes a stator with a central hole and multiple coils arranged in a distributed winding configuration, the motor being a multiphase switched reluctance brushless direct current motor, the multiple coils comprising phase coil groups for the multiphase switched reluctance brushless direct current motor, the stator including multiple protruding stator teeth, and
wherein the stator includes multiple laminations and insulating materials that wrap around the laminations.

20. The blower according to claim 19, wherein the non-integral tube is constructed with two parts, the two parts being separated with a gap inside the blower.

21. The blower according to claim 19, wherein the motor includes a flange configured to support the blower housing.

22. The blower according to claim 19, wherein the rotor assembly includes a metal component configured to contact and secure the impeller.

23. The blower according to claim 19, wherein the rotor assembly and the stator are coaxially aligned and do not form a gas gap.

24. The blower according to claim 19, wherein the gas does not flow through an interior of the stator assembly.
